(19) United States
(12) Patent Application Publication
(10) Pub. No.: US 2014/0101139 A1
(43) Pub. Date: Apr. 10, 2014

(54) METHODS AND DEVICES FOR QUERYING DATABASES USING ALIASING TABLES ON MOBILE DEVICES

(71) Applicant: Talvis LLC, Ashburn, VA (US)

(72) Inventors: Brett Adriaan van GEMERT, Ashburn, VA (US); Kevin James BERMINGHAM, Ashburn, VA (US)

(73) Assignee: TALVIS LLC, Ashburn, VA (US)

(21) Appl. No.: 14/046,091

(22) Filed: Oct. 4, 2013

Related U.S. Application Data
(60) Provisional application No. 61/709,876, filed on Oct. 4, 2012.

(51) Int. Cl. G06F 17/30

(52) U.S. Cl. CPC G06F 17/30545; G06F 17/30554
USPC 707/722; 707/771; 707/770

(57) ABSTRACT

A method for responding to natural language financial performance queries received from a user device is provided herein. The method may include: receiving a first spoken natural language request from the user device; parsing the request into words, using a processor; searching a table of natural language words and keywords to determine whether the request includes any of the words stored in the table; generating instructions for querying a database based on one or more keywords; receiving financial information responding to the query from the database; and transmitting the financial information to the user device for display in a graphic format and/or for playback of an audio.

### CROSS REFERENCE TO RELATED APPLICATIONS

This application is a non-provisional application of U.S. Provisional Application No. 61/709,876, filed Oct. 4, 2012, the entire content of which is incorporated herein by reference.

### FIELD OF THE DISCLOSURE

This relates to efficient data management systems, devices, servers, and methods that allow for efficient querying of one or more databases using a communication device.

### BACKGROUND

Companies use multidimensional databases to store financial and metric data. Each “dimension” in a database describes an attribute of a particular data point. For example, assume the revenue in January 2012 for product A in a Boston store was 120 dollars. The data point, 120, may be described by the following five dimensions:

| | |
|---|---|
| Account - revenue | Month - January |
| Year - 2012 | Product - A |
| City - Boston | |

Most financial/metric multidimensional databases contain tens of dimensions (e.g., 10-12 dimensions) and store tens of millions data points (e.g., 10-20 million data points). Such databases may be an efficient way to store, query and report information. However, these databases are not often utilized by most financial executives of a company or by senior managements of a company because the terminology used is difficult to understand and member names in databases are not intuitive. Member names are the actual values (e.g., computer readable values or computer readable language) within a dimension. For example, the “Account” dimension may have member names such as AC_Rev, AC_AdminExp, AC_T&E, etc. To effectively query a database, a person would need to learn, and be proficient in, a querying language/software such as SQL, MDX, Hyperion Smart-view, or Cognos TM1. Further, because the actual member names in a database may be AC_Rev, Prd_A, Cy_Boston.US, the person retrieving the information may need to know the exact spellings of each of the dimension member names in order to formulate an effective query.

Thus, in most companies, a select few Financial Planning and Analysis (FP&A) analysts, information technology analysts or marketing analysts become experts in retrieving information and, therefore, most requests are funneled to them. This creates an inherent bottleneck and limits the access and distribution of information. Typically, a senior executive may have a question and may send an email to an FP&A group for an answer. The FP&A analyst will read the email, connect to database, set up a query, extract information, format the information data, build a chart and send the organized information back to the requestor. This process can take a ½ hour to a day depending on the FP&A resources available.

### SUMMARY

As mentioned above, a need exists for the existing multidimensional database systems to develop systems that can allow a person with even a low level of computer language skills to generate a query and receive answers to the query, thereby expediting the querying process for the convenience of the person. Also, such an efficient query system may bring many advantages to businesses as it may allow it to achieve the “information at the speed of thought.” It is well known that in today's digital economy, businesses are not likely to succeed without integrating with technology and taking advantages of it—e.g., efficient networking and information technology.

Various embodiment of the systems/platforms disclosed herein may be referred to as, collectively, “the system(s)” “the server(s),” or “the platform(s).” The system may refer to an interactive communication system among a number of different devices, such as, not-exclusively, a server, a database, a plurality of (i.e., one or more) user devices.

Using the systems according to the disclosure, a user may easily input a request for a query in a natural language, receive desired information within a few seconds, and see the information displayed on a screen in a graphical format.

Further, a person may query a database without knowing how to connect to a database, how to select a database that contains the desired information, how to use a querying software tool or computer language, and/or the architecture and naming nomenclature of all members within the databases.

In some embodiments, a query may be generated using an intuitive, simple interface containing voice recognition. Alias tables may allow a person interested in initiating a query to ask questions in natural language (e.g., English). Further, intuitive alias tables may associate single keywords within a query to multiple possible members, thereby allowing accurate mapping between natural language words (members) and keywords.

In some embodiments, the systems may be implemented on a server with a processor that is configured to communicate with a user device and a database server. A separate server for voice recognition and text conversion may be used.

In some embodiments, the systems may be customized to a proprietary financial database service such as Hyperion® Essbase®.

In some embodiments, the systems may be implemented for various types of user electronic devices including a mobile device (e.g., smartphone) and a personal computer (e.g., a laptop) to generate queries from any location at any time.

In some embodiments, the systems may have a built-in logic to read back the queried data in a natural language (e.g., English sentence), for example, by converting the information received from the server in a text file into a sound file. The systems may also organize or arrange the queried data in various types of graphical formats (e.g., a table, a grid, a chart, a chat, etc.).

In some embodiments, a method may be provided for responding to natural language financial performance queries received from a user device. The method may comprise: receiving a first request for a query from the user device, the request being a text string of a natural language; parsing the first request into one or more parsed natural language words, using a processor; searching a table of natural language words and keywords to determine whether the parsed natural language words match the natural language words in the table; generating instructions for querying a database based on one or more keywords corresponding to one or more matched natural language words in the table; receiving first information responding to the first request from the database; and transmitting the first information to the user device.

In some embodiments, the method may comprise: receiving a second request from the user device; determining that the second request is associated with the first request; and transmitting second information responding to the second request and at least a part of the associated first information together to the user device.

In some embodiments, the method may comprise: receiving a second request from a second device different from the user device; determining that the second request is associated with the first request; and transmitting second information responding to the second request and at least a part of the associated first information together to the second device.

In some embodiments, the second request may be determined to be associated with the first request based on one or more natural language words in the second request corresponding to one or more keywords in the table.

In some embodiments, the keywords in the table relate to financial information stored in the database. One or more keywords may also be associated with computer instructions for querying a financial database.

In some embodiments, the transmitted information may be a graphical representation of financial information. The transmitted information may also be a chart or a table representation of financial information. The transmitted information may be converted to an audio for playback on the user device.

In some embodiments, the method may comprise selecting a database from a plurality of databases based on one or more parsed natural language words in the first request matching one or more natural language words in the table. The method may also comprise selecting a database from a plurality of databases based on one or more previous requests received from the user device.

In some embodiments, another method may be provided for communicating with a server for natural language financial performance queries. The method may comprise: receiving a first spoken natural language request for a query from a user; transmitting a first text request corresponding to the first spoken request to the server; receiving first financial information responding to the first request from the server; and displaying the first financial information.

In some embodiments, the method may comprise: receiving a second spoken natural language request for a query from the user, the second request being associated with the first request; and transmitting a second text request corresponding to the second spoken request to the server; displaying second financial information responding to the second request and at least a part of the first financial information together.

In some embodiments, the method may further comprise: converting the first spoken natural language request input by the user to the first text request via a plug-in. Alternatively or additionally, the method may comprise: transmitting the first spoken natural language request input by the user to a voice recognition server, the voice recognition server converting the first spoken natural language request to the first text request; and receiving the first text request from the voice recognition server. Also, the method may comprise converting the first financial information received from the server to an audio, and playing the audio.

In some embodiments, the first financial information may be displayed in a chart or a table format. The second financial information and the first financial information may be displayed together in a chart or a table format.

In some embodiments, the method may also comprise: receiving a second spoken natural language request to edit the displayed financial information; and re-displaying the financial information edited in accordance with the second request. The method may comprise: receiving a second spoken natural language request to share the displayed information with a second device; and transmitting the displayed information to the second device.

In some embodiments, the second request may comprise at least one of a request to remove a certain part of the information displayed, a request to rearrange a certain part of the information displayed, a request to add a new information on the display, a request to replace a certain part of the information displayed with a new information, a request to display more detail on a certain part of the information displayed, and a request to display less detail on a certain part of the information displayed. The second user device may be located remotely from the user device.

In some embodiments, a system may be provided for responding to natural language financial performance queries received from a user device. The system may comprise a central server and a plurality of user devices each configured to communicate with the central server. The system may be operable to work as a platform for processing queries received from the user devices. The central server may include a processor and perform: receiving a first request for a query from the user device, the request being a text string of a natural language; parsing the first request into one or more parsed natural language words, using a processor; searching a table of natural language words and keywords to determine whether the parsed natural language words match the natural language words in the table; generating instructions for querying a database based on one or more keywords corresponding to one or more matched natural language words in the table; receiving first information responding to the first request from the database; and transmitting the first information to the user device.

In some embodiments, at least one of the plurality of user devices may include a processor and perform: receiving a first spoken natural language request for a query from a user; transmitting a first text request corresponding to the first spoken request to the server; receiving first financial information responding to the first request from the server; and displaying the first financial information.

In some embodiments, a server may be provided for responding to natural language financial performance queries received from a user device. The server may comprise: a receiver receiving a first request for a query from the user device, the request being a text string of a natural language; a processor parsing the first request into one or more parsed natural language words; a processor searching a table of natural language words and keywords to determine whether the parsed natural language words match the natural language words in the table; a processor generating instructions for querying a database based on one or more keywords corresponding to one or more matched natural language words in the table; a receiver receiving first information responding to the first request from the database; and a transmitter transmitting the first information to the user device.

In some embodiments, a mobile communication device may be provided for communicating with a server on financial performance related queries. The device may comprise: an input device that receives a request for a query from a user; a transmitter that transmits the request input by the user to a server; a receiver that receives financial information responding to the query from the server; and a display that displays the financial information. The mobile communication device may be a mobile phone with a screen (e.g., a smart phone).

In some embodiments, the financial information may be converted into an audio by the device or by an external server, and the financial information can be both displayed and read back by the device. For example, the graphical representation of the financial information may appear on a display of the device while the audio representation of the financial information is also played.

In some embodiments, if the financial information is displayed, and a user inputs a spoken request to run the same query again, the transmitter may transmit the request to the server again, and the receiver may receive updated financial information from the server. The user may input a follow up request (e.g., to run, modify, add, remove the previous query again, etc.) using a second device that is remote from the device that initiated the previous query.

### BRIEF DESCRIPTION OF THE DRAWINGS

FIG. 1a depicts an example of query platform architecture.

FIG. 1b depicts another example of query platform architecture.

FIG. 2 depicts an example of a processing flow of a query platform.

FIG. 3 depicts an example of a setting panel that may be displayed on a user device in a query platform.

FIG. 4 depicts examples of visuals that may be displayed on a user device in a query platform.

FIGS. 5a and 5b depict another example of a processing flow of a query platform.

FIGS. 6A-6C depict a number of exemplary screen views of a setting panel that may be displayed on a user device in a query platform.

FIGS. 7A-7D depict a number of exemplary optional screen views for displaying the query results on a user device in a query platform.

### DETAILED DESCRIPTION

Various embodiments and examples described herein relate to providing users the ability to easily formulate and launch queries and promptly receive query results that will significantly enhance the user efficiency and convenience. For example, a user may launch a query by merely speaking what they want in their natural language. Users need not be experts in a querying language or database structure.

For example, a person who wants to know how much revenue there was in January for Product A in the city of Boston may instantaneously receive the result. In accordance with the present disclosure, a person may launch a query by, for example, speaking or typing in a query/question into a device (e.g., mobile device, mobile smartphone) using a natural language (e.g., English) and be provided an answer or other results to the query within a few seconds (e.g., three seconds or less). In contrast, existing processes may require certain experts to handle the query, where the total response time can take a ½ hour to a full day.

The systems according to the present disclosure may automatically convert the spoken, natural language query to a computer-readable query, select a correct database and return a result to the user. This entire process may be instantaneous, thereby improving the speed and efficiency of the communication and reporting process. “Instantaneous” as used in this disclosure refers to a period of time that is less than a minute, preferably less than 30 seconds, more preferably less than 10 seconds, and still more preferably less than 5 seconds.

In some embodiments, query results may be displayed dynamically in several different views—e.g., a chat screen, a chart screen or a report screen. Further, users may launch successive queries building on the previous queries, or share the query results with others, who in turn can run the same queries or build on the received queries with follow up queries. Various options and examples are detailed below.

The systems may include one or more devices such as a server, a database, a processor, a communication network component or any other devices necessary to implement any of the claimed features, as will be apparent to one of ordinary skill in the art. For the convenience of explanation, a reference to the query platform in the present disclosure may be equal to or include a reference to any one or more components of the query platform (such as a server, a communication network for the platform), or an overall query system including the user-side.

One of representative examples of a technological concept of the present disclosure will be described more fully hereinafter with reference to the accompanying drawings, in which illustrative embodiments of the present disclosure are shown. These examples may, however, be embodied in many different forms and should not be construed as limited to the embodiments set forth herein; rather, these embodiments are provided so that this disclosure will be thorough and complete, and will fully convey the scope of the claims to those skilled in the art. Like numbers refer to like elements throughout. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another element. Thus, a first element discussed below could be termed a second element without departing from the scope of the present disclosure.

The terminology used herein is for the purpose of describing particular embodiments only and is not intended to be limiting of the claims. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the present disclosure may be embodied as a method, data processing system, or computer program product. Furthermore, the present disclosure may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the embodiments of the present disclosure may be written in an object oriented programming language such as Java®, Smalltalk or C++. However, the computer program code for carrying out operations of the embodiments of the present disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present disclosure is described in part below with reference to flow chart illustrations and/or block diagrams of methods, apparatus (systems) and computer program products according to embodiments of the present disclosure. It will be understood that each block of the flow chart illustrations and/or block diagrams, and combinations of blocks in the flow chart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flow chart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flow chart and/or block diagram block or blocks.

The systems according to the disclosure may communicate with one or more user devices. The user devices may include mobile devices such as a mobile phone, a smart phone, a laptop and may also include stationary devices such as a personal computer or other similar devices. The user device may include an input unit that allows a user to type in a text command.

The user device may further include a voice receiving/recognizing unit or a plug-in that allows the device to accept user's spoken command, recognize it and/or convert it to a text string such that the voice recognition and conversion may take place inside the device. Additionally or alternatively, the user device may have a plug-in that accepts user's spoken command, sends audio to an external server for voice recognition and conversion to text, and receive the text string corresponding to the audio from the external server.

Further, any one or more devices in the systems may operate on one or more processors. The processors may be implemented on one or more programmable microprocessors or specialized integrated circuits. Any one or more devices in the systems may also include a memory or any recordable medium or storage medium capable of storing the program instructions, tables, database information (e.g., member names, revenue, sales). These memories may take various forms such as a primary memory, a volatile memory and a non-volatile memory—for example, an optical drive, a RAM, a DRAM, a CPU cache, a SRAM, a ROM/EEPROM/EPROM, etc.

Further, any one or more devices in the systems may communicate through various types of network. For example, the server, the user device(s), and the database in the systems may communicate between themselves through any one or more of the following: a wireless network, Internet, a telecommunication network, a proprietary network, a wired network, or any similar network.

Further, the systems/platforms disclosed herein may be customized for any existing financial database systems such as Hyperion® Essbase®, which is a multidimensional database system that provides “on-line analytical processing” (OLAP). The systems/platforms may be customized for any other OLAP database management systems as well.

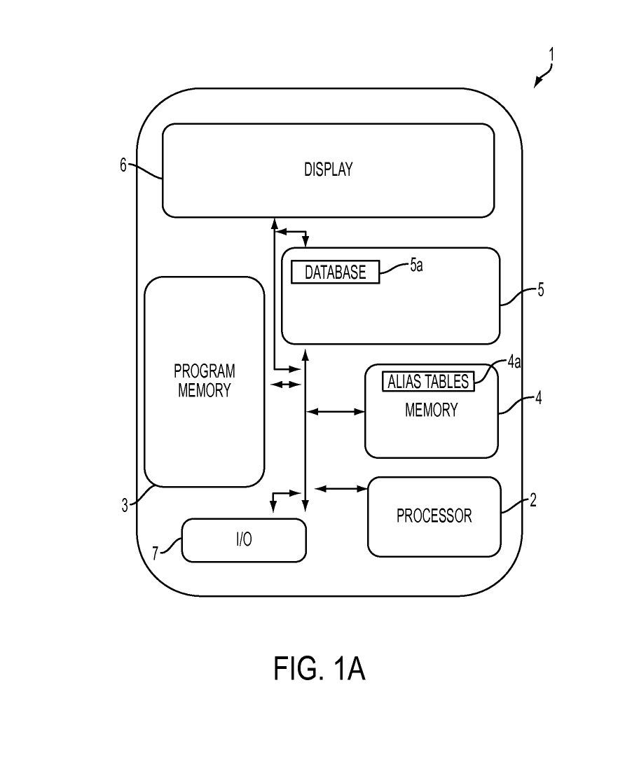

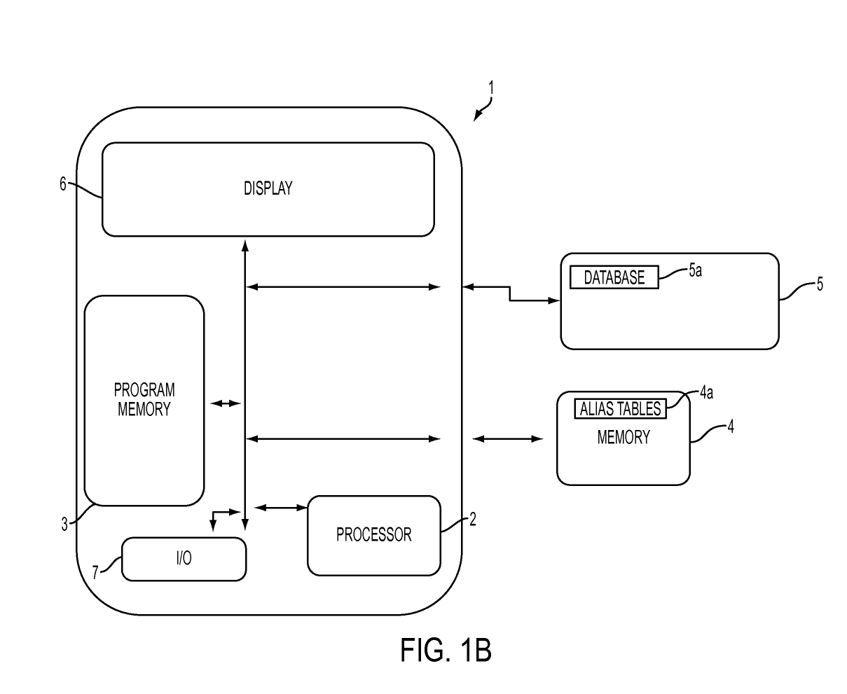

Referring to FIG. 1a, there is depicted an exemplary device 1. The device 1 may comprise a processor 2 that is operable to access and execute instructions stored in one or more program memories 3 to map one or more words in a spoken query to one or more corresponding database member names stored in a database 5a of a database memory 5, such as a multidimensional database, for example. In general, it should be understood that each of the functions performed by the processor 2 described herein may be completed by the processor 2 accessing and executing instructions (e.g., a program) stored in the one or more program memories 3.

The processor 2 may be operable to access executable instructions from memory 3, for example, to receive information (i.e., a query) input by a user of device 1 (“user”) input verbally, typed in, or otherwise via input/output (I/O) circuitry 7. The processor 2 may be further operable to thereafter compare words in the query to keywords that are stored in one of the memories 3-5 such that when these keywords are input, highly relevant information may be retrieved from database 5a, for example. In some embodiments, there is no need to load Microsoft Excel or other 3^{rd} party software in order to build, for example, a multidimensional query. This saves resources and time in producing the query and results.

In some embodiments, the processor 2 is operable to access information in one or more alias tables 4a stored within aliasing table memory 4 in order to complete the comparison mentioned above, as explained in more detail below. Yet further, the processor 2 may be further operable to map one or more database member names, for example, AC_Rev, to revenue and sales information stored in the database 5a, for example, using the aliasing tables 4a. For example, through the use of alias tables that are explained below, multiple inputted variables (e.g., different words and phrases in a query) may be used and then mapped to the corresponding part of a database (e.g., to the part associated with a database member name).

The processor 2 may be implemented as, for example: one or more programmable microprocessors, or another type of programmable, computer readable medium, or one or more specialized integrated circuits. The program memory 3, aliasing table memory 4 and database memory 5 may comprise, for example, any suitable recordable medium or storage medium capable of storing the program instructions, aliasing tables 4a and database information (e.g., member names, revenue, sales). Though the program memory 3, aliasing table memory 4, and database memory 5 are depicted as three separate memories, it should be understood that these memories can be combined into one, or further broken down into additional memories. For example, the alias table memory 4, and/or aliasing tables 4a may be a part of program memory 3. Alternatively, the instructions/programs, aliasing tables and database information within memories 3-5 may be stored in one or more recordable mediums separate from memories 3-5 that may be accessed by the processor 2 via an interface (not shown). Such a medium may comprise external or internal mass storage media of a mass storage unit.

Most commonly, the alias table memory 4, alias tables 4a, database memory 5 and database 5a will not be a part of the device 1 for space, cost and security reasons.

FIG. 1 b depicts an exemplary device. In some embodiments, an external server may function as database 5, for example. By placing the functionality of the aliasing tables 4a and/or databases 5a on an external device there may be no need for the device 1 to store and maintain the information that is a part of database 5a. Instead, the device 1 need only store a limited amount of information related to the query in a memory 3 (or 4) and any results generated by the device 1 in response to a query.

Further, security may be enhanced because a given user has limited or no access to the information in the database 5a and/or aliasing tables 4a. If access is required, a user may be required to input a user name and an approved password to access the database 5a and/or aliasing tables 4a as well as to access the device 1 to initiate a query. Yet further, prior to displaying or otherwise communicating results associated with a query to the user, a password may also be required. While components of device 1 are shown to be directly coupled to each other, it should be understood that device 1 may include a variety of other circuitry or software components which are not necessarily shown, but that are disposed between, or otherwise associated with, the illustrated components of device 1. Such circuitry may include power supplies, clock circuits, cache memory, additional input/output circuitry and the like, as well as specialized circuits that may be used in conjunction with the processor 2 to complete functions in accordance with executable instructions and programs stored in memory 3. The additional input/output circuitry may be used to form interfaces between the various elements shown in FIGS. 1a and 1b.

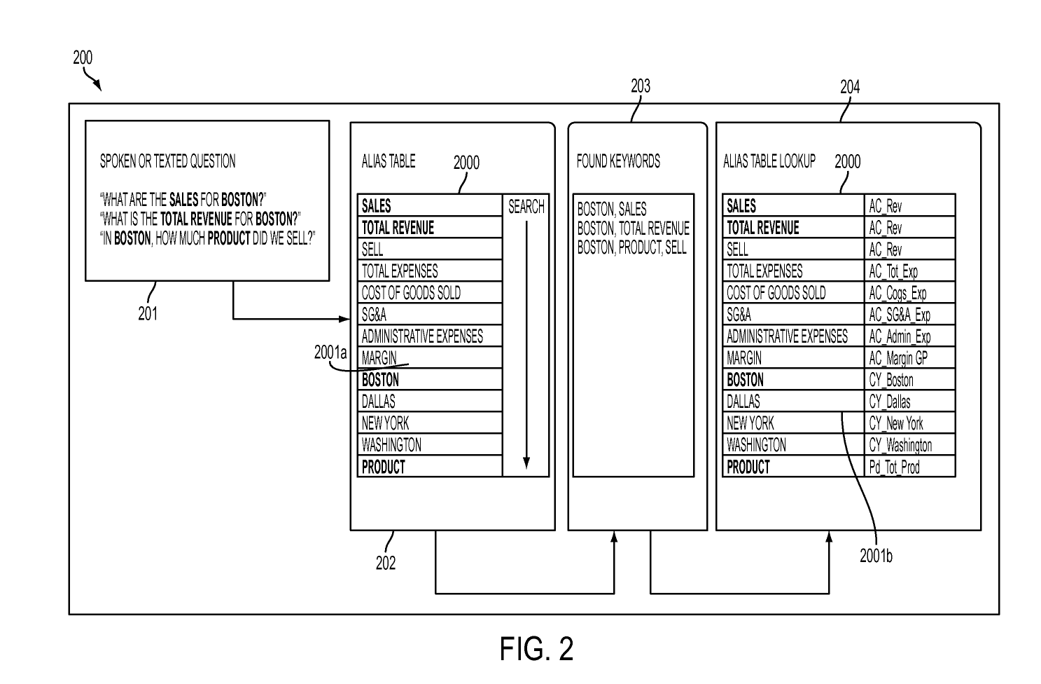

Referring to FIG. 2, there is depicted a flow diagram of an exemplary process or method according to some embodiments of the invention. Using the example of a person that wants to know how much revenue there was in January for Product A in the city of Boston, a person may launch a query by, for example, speaking or typing in a query/question into device 1 (e.g., mobile device, mobile smartphone, etc.) using a natural language (e.g., English) in step 201.

For example, the user could launch a query by verbally speaking “What are the sales for Boston?,” “What is the total revenue for Boston?” or “In Boston, how much product did we sell?” as depicted in FIG. 2. The user may also simply type in natural language queries using an input device such as a keyboard, a touch pad, etc.

In some embodiments, the spoken request for query is converted into a textual representation, and the platform formulates a query based on the textual representation. The platform may also utilize a third party vendor for the voice recognition and text conversion functions and receive the converted textual representation of the requests from the vendor.

Referring to FIG. 2, in some embodiments, the query analysis includes recognizing one or more keywords included in the text version of user's request written in natural language, associating the one or more keywords to certain computer readable query language. For example, upon receiving user's request, the platform/system 200, which may include one or more processors, may be operable to search the contents 2001a of one or more aliasing tables 2000 in order to compare the contents 2001a to texts/words in the query, in step 202. The contents 2001a of an aliasing table 2000 may comprise a plurality of keywords. Thus, the comparison may comprise comparing the plurality of keywords 2001a with words in the query to identify those that match, in step 202. As shown in FIG. 2, those that match, for example, Boston, Sales, Total Revenue, Product, Sell, are identified in step 203.

Upon identifying one or more keywords, the platform/system 200 may be further operable to associate the matching keywords from step 203 with one or more members 2001b (e.g., “AC_Rev”) associated with highly relevant information stored in database 5a, for example, in step 204. It should be understood that a member, e.g., AC_Rev, may be associated with a number of keywords in an aliasing table. This enables a user to formulate and launch queries using the keywords (e.g., names or phrases) they prefer.

Still further, it should also be understood that some keywords (also known as “aliases”) may be associated with an “array” of members. For example, an alias such as “all months of Q1”, which may not refer to a single member, may refer instead to an array or list of members, such as JAN (January), FEB (February), and MAR (March). In another example, the member AC_Rev referred to above may be a part of an array or list of members that are associated with a keyword named “all accounts.” As is apparent from the discussion above, by “keyword” is meant one word and/or a phrase consisting of more than one word.

Still further, the platforms/systems may have a keyword recognition feature that is dependent on the source that user utilizes. For example, every user speaks in different ways and asks for things in a different manner than they would do in a written form. So, the platform may store different set of aliasing tables where one set is used for verbal, spoken requests, and the other set is used for text requests. Other criteria for using different aliasing tables may be used—such as user's location, user's previous queries, user's pre-designated preference, etc For example, the platform may be programmed to default to using different alias tables depending on user's location, keyword analysis, user's previous queries, etc. Users can always overwrite the default values.

Referring to FIG. 2, in some embodiments, the platform/system 200 may analyze queries and retrieve information from the database 5a quickly because it may assume pre-defined, adjustable default values for a dimension. That is, if a dimension and its value are not specifically identified in a query, the processor(s) in the platform/system 200, which the processor 2 may or may not be part of, can assume one or more pre-defined, adjustable default values. For example, if a user does not input the “Year” dimension in its query, a pre-defined, adjustable default value for this dimension may be assumed (e.g., the current year of the query) by the processor. This means that a user may not have to input all of the dimensions (e.g., 10 to 12) that typically make up a spoken or written query (text), but, nonetheless, will still receive accurate response/results.

Yet another example will help illustrate the point further. Some users are interested in receiving actual information, not budget, forecast, or long range planning information in response to a query. Such users can simple input a query “what is the revenue for May?” as a spoken sentence (leaving out the word “actual” for example) and the platform/system 200 may analyze the query and assume the user actually meant the actual revenue for May. Other users are, in fact, only interested in budgetary revenue. In such a scenario upon receiving a query “what is the budget revenue for May?” as a spoken sentence from a user, the platform/system 200 may be operable to replace the default actual value with a budgeted value in the query.

The default values may be automatically selected and/or updated based on pre-designated factors such as the current year, user's current location, user's previous queries, etc., but may also be manually selected and/or changed.

In some embodiments, there may be interactive features embedded in the platforms/systems. For example, there may be a banter response feature embedded in the system, which allows user to chat with the system. This may be useful when user inputs a query request, and the platforms/systems recognizes that the inputted request does not contain enough information to select a database and generate an appropriate query—for example, if user merely inputs “what is the profit?,” the platforms/systems may dynamically respond to user asking designation of geographical area(s) and time period(s) to which his/her request should relate to. Alternatively, if the corresponding default values were stored for missing dimensions, the platforms/systems may ask a verification from the user on the default values and prompt him/her to confirm the default values or if they are incorrect, change them to desired values.

Further, there may also be a follow-up questioning feature embedded in the system, which allows user to initiate a follow up query based on a previous query. For example, in the real world, it is usually not enough for someone to answer just one question. Usually, a manager will request further details as opposed to being satisfied with a high level response. The platform/system 200 may handle this using the follow up query feature. By asking a question such as “what's the profit for Boston in 2011 ?,” a user may ask a follow up question such as “what about Chicago?,” and then the platform may recognize that this is a follow up query to the previous query for Boston and aquatically run a 2011 profit query for Chicago.

For example, some exemplary follow up queries are listed below:

TABLE 1
Follow-up query options

| Follow-up queries | Corresponding results |
|---|---|
| “Can you include X?” (e.g., can you | Add to your query |
| include Chicago, 2010 profit report, etc.?) | |
| “Can you remove X” (e.g., can you remove | Remove from your |
| Boston, 2011 profit report, etc., from the | query |
| chart/report?) | |
| “Can you substitute X for Y?” (e.g., | Substitute information |
| can you substitute Boston for Chicago?) | in your query |
| “Give me more detail on X.” (e.g., give | Get more detail on your |
| me more detail on Boston sales including | query/Display more detail |
| sales per subdivision, per item, etc.) | (e.g., displays sub- |
| | dimension information) |
| “Give me less detail on X.” (e.g., give | Get less detail on your |
| me less detail on Boston sales.) | query/Display less detail |
| | (e.g., removes sub- |
| | dimension information) |
| “What about X?” (e.g., what about | Switch out members in |
| Chicago, or 2011?) | your query |

Referring to Table 1, “X” may mean a specific geographical area or a time period as shown in the examples provided inside the table, but is not limited to these examples. In fact, “X” may be any dimension that may define the relevant data, for example, for the financial data, a profit, a total revenue, a net loss, a total loss, profit per specific product or item, etc.

Further, in some embodiments, the user device may be configured to store query results received from the server such that when a user makes a follow up request to merely modify the display configuration of the stored query results (e.g. removing certain information, switching orientation or order of the display, etc.), the user device can handle the request without contacting the query-processing server again and getting the modified information from it. This may reduce the processing time. Of course, when the user makes a follow request for a different query, the user device will need to contact the query-processing server. Alternatively or additionally, the system may be configured such that the user device contacts the server for all types of requests regardless they require a new query or not, in order to ensure that the most recent information (i.e., most up-to-date query result) is displayed on the user device.

Still further, the follow-up query feature does not need to be limited to the same user who initiated the base query. Instead, a user may run a first query and transmit the result of the first query to a second user (e.g., manager) who is located remotely from the first user. When the second user receives the results using a reception device (e.g., a computer or a mobile device), the manager can initiate a subsequent query (a follow up query) using his/her reception device. The platforms/systems may recognize that the second user's query request is a follow up query to the first query result and generate appropriate results that include the results of both the first query and the second query.

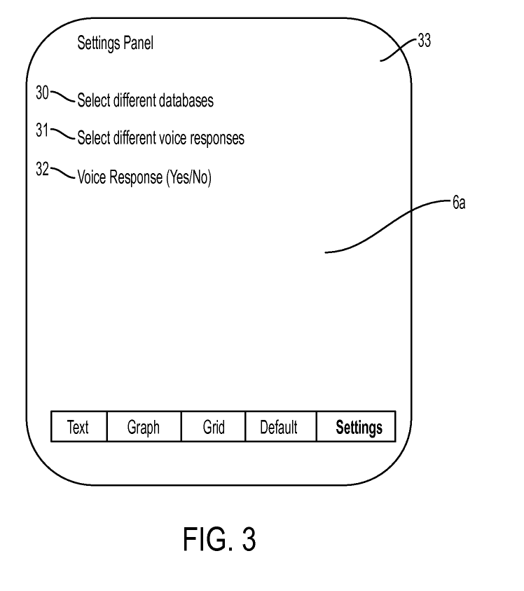

Referring to FIG. 3, there is shown an example of a settings panel 33 that includes user input options 30-32. Once a user accesses the device 1 by logging in, for example, the user may see a display similar to the exemplary display 6a in FIG. 3. In some embodiments, the user may make a selection from the selections 30-32 to select a database or databases using selector 30, select a particular voice response from a number of voice responses using selector 31 or select/de-select a voice response in lieu of a textual response using selector 32. To output a voice response, an audio section (not shown in FIG. 1) may generate an audible wave file. The wave file may then be output to the user. While three input options 30-32 are depicted in FIG. 3, it should be understood that this is for illustration purposes only. More, or less, options may be included.

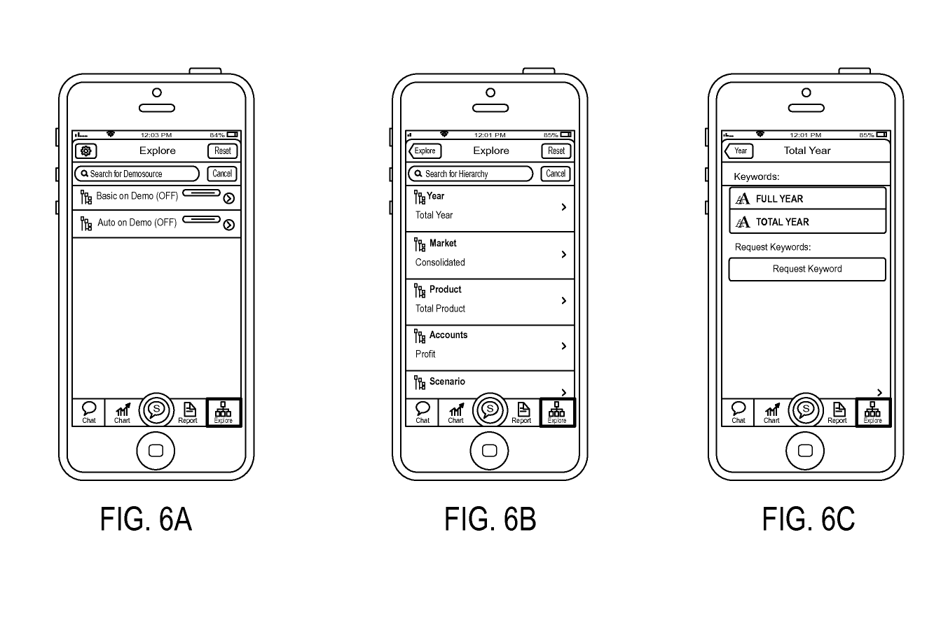

For example, FIGS. 6A-6C illustrate a number of exemplary screen views of a setting panel for setting various other query criteria. FIG. 6A illustrates an exemplary screen view of a setting panel listing two data sources (“Basic on Demo” and “Auto on Demo”). Both sources are deselected for queries.

In some embodiments, there may be provided a setting screen allowing user to select or deselect one or more databases. In some embodiments, all available data sources may be displayed on the setting screen, and a user may toggle them on or off. The platforms/systems may automatically choose the best data source to query based on the spoken or texted query requests. As explained above, the platforms/systems may consider one or more of the following factors in determining the best source/database to the query: keywords in the request, user's current location, user's previous queries (going back to a predetermined number of queries such as past 5 queries or 10 queries, etc.), etc. However, user may also want only to query on a specific database.

Further, in some embodiments, when new metadata enters the system (e.g., cost centers, accounts, projects, etc.), the relevant data source and dimensions may be highlighted with a “new” sign or otherwise signaled to users. A similar notification (such as a “unsynchronized” sign) may be employed for unsynchronized data points, which are the metadata that have not been synchronized with other setting criteria such as keywords, display and other properties of the data points.

FIG. 6B illustrates an exemplary screen view of a setting panel listing five database dimensions showing their respective default values under their names. For example, “Year” dimension is defaulted to total year; “Market” dimension is defaulted to consolidated market, “Product” dimension is defaulted to total product; and “Accounts” dimension is defaulted to profit.

In some embodiments, users may also drill down into the database dimensions to select or de-select certain dimensions. All available database dimensions may be displayed on the setting screen, and for those that have set default values, the default values may also be displayed. Users may choose any one or more of the listed dimensions to set the default value, change the default value, or turn-off or remove the default value.

While the setting screen may be used to manually modify the default value settings, as explained above, the default value may be set by simply querying. For example, the platforms/systems may set the default values for various dimensions based on previous queries (going back to a predetermined number of queries such as past 5 queries or 10 queries and selecting the most common values for respective dimensions as their default values).

FIG. 6C illustrates an exemplary screen view of a setting panel listing keywords and its members, allowing users to register or de-register certain members (certain words or phrases) from the keywords.

In some embodiments, users may view keywords associated with the selected member. The keyword screen may show what words users can say or text to retrieve the member value. For example, a user may say “show me the results for the full year” or “show me the results for the total year,” and in both cases, the results for the total year would be returned. In another example, a city such as New York may be given the keyword “Big Apple,” a query such as “show me the results for the Big Apple” would return “New York.”

Users may also request keywords for different members. In the example shown in FIG. 6C, user may click the button located at the bottom. A user may request addition of the keyword as well as its removal.

Further, a setting panel may allow users to enable or disable sound (voice read back), select voice read back type (selecting the voice type) and customize users' names and other personal information. Described above are merely exemplary, and any other options may be included in the setting feature of the platforms/systems.

Referring to FIG. 3, depending on the voice option set up, a user may input a query verbally, or type in a question in a text box (not shown in FIG. 3, because these are well known). To receive verbal queries, the device may further comprise known audio reception circuitry (not shown in the figures) for receiving the spoken words and forwarding the words to a voice recognition section (also not shown). In yet another example, the voice recognition section may be an external system that has voice recognition capability. In the later type of voice recognition capability, the forwarded words (i.e., their electronic representation) may be received by a “cloud-based” service that translates the words and sends a text-based response to the user's spoken request back to the device 1, in which case the device 1 sends the text-based response to the platform/system 200, or directly to the backend server in the platform/system 200.

The platform/server 200 may then analyze the text string within the text-based response and identify keywords, database names and members. The platform/server 200 may be further operable to generate a query structure that includes one or more internal queries. Thereafter, the platform/server 200 may forward the one or more internal queries to the database 5a. Upon receiving results from the database 5a, the platform/server 200 may be operable to store the results in memory 3, for example. In a further embodiment of the invention, the platform/server 200 may be operable to organize the results in a proper grammatical (e.g. English) sentence, and display the results within a text box of display 6a.

At the same time (or later as desired) that a response is generated, the device 1 (e.g., processor 2) may be operable to build one or more charts, tables and/or grids and the like (collectively referred to as “visuals”) and display the visuals on a display, such as display 6 in FIG. 1. The device 1 may be operable to generate visuals where the data within the visuals is organized in a best fit, best display format. Once generated and/or displayed, the visuals may be modified in accordance with user preferences as well. Alternatively or additionally, the visuals may be generated by the backend server of the platform 200 and outputted to the user device ready for display.

In addition, programs stored as instructions in memory 3 or the like may be accessed and executed by the processor 2 for assigning the x axis, y axis, series, title, and scale values to each visual, for example. The device 1 may be operable to generate one or more visuals that may, for example, be swiped (e.g., Iphone® swipe touching the display and sliding finger from right to left) into view based on the results. These visuals may be dynamic (e.g., ever changing, updated). For example, periods (months, quarters) can be added or deleted by the user by verbally requesting (e.g., “Add January and February” or “remove quarter”) or otherwise inputting a request into the device. Alternatively or additionally, these visuals may also be generated by the backend server of the platform 200 and outputted to the user device ready for display.

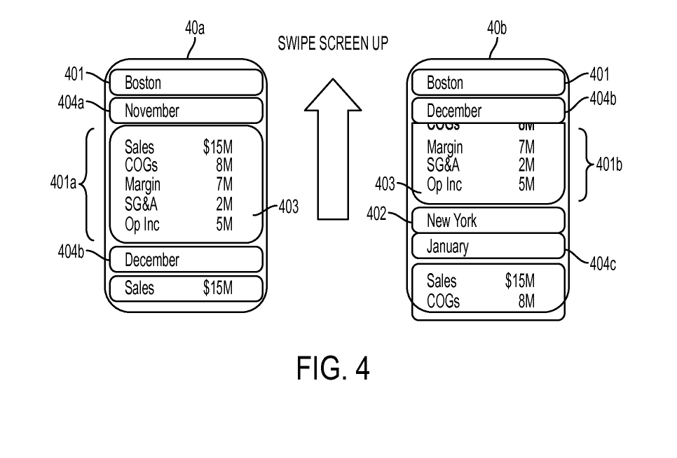

Referring to FIG. 4, there are shown exemplary visuals 40a, 40b that may be generated and displayed using the components shown in FIG. 1, for example. By way of example only, assume the following query: All months, all markets, P&L data. Given such a query, the size of a corresponding visual containing the results of such a query may extend well beyond the screen of a typical mobile device (e.g., smartphone). Realizing this, device 1 may be operable to allow the user to swipe/scroll down the visual in order to select dynamically displayed, so-called “sticky” header types (e.g., months, market/cities). As the user scrolls from one section of the visual to another (e.g., one month to another month) the previous sticky header 404a may be replaced by a current header 404b. Further, multiple types of sticky headers and their associated information may be displayed and scrolled through. For example, one sticky header type related to months 404a, 404b, 404c and a second sticky header type related to markets 401, 402 may be simultaneously displayed and scrolled through along with their associated information.

In some embodiments, the visual 40a may initially depict the month of November's 404a P&L information 401a for the city (market) of Boston 401. Thereafter, as the user scrolls down the visual 40a (e.g., swipes upwards), the active display area 403 may change to include similar information 401b for the month of December 404b, forming new visual 40b. Similarly, information for a different type of sticky header other than a month may be displayed. In the example shown in FIG. 4, information for a market type of sticky header (e.g. New York 402) may be displayed by touching or otherwise activating the sticky header, for example.

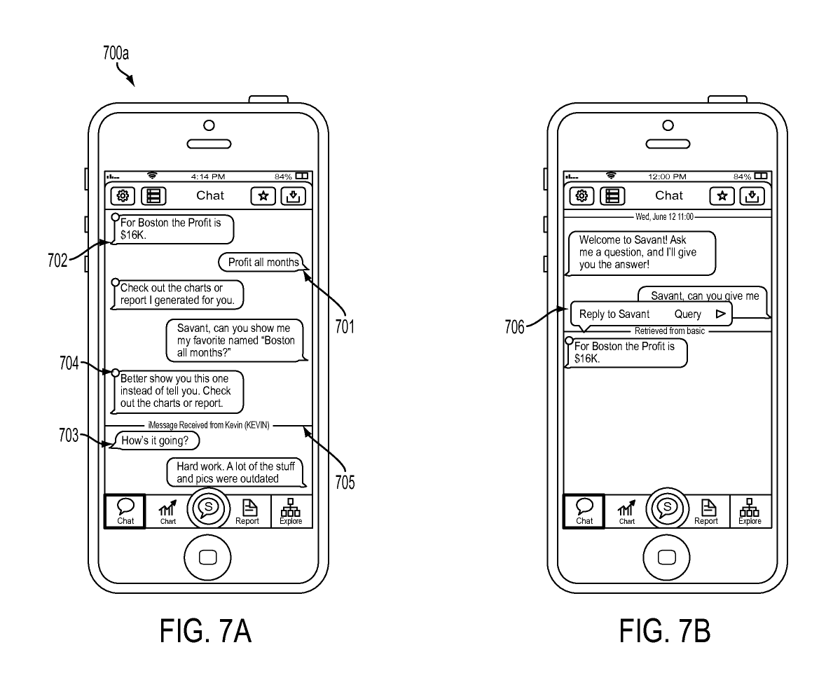

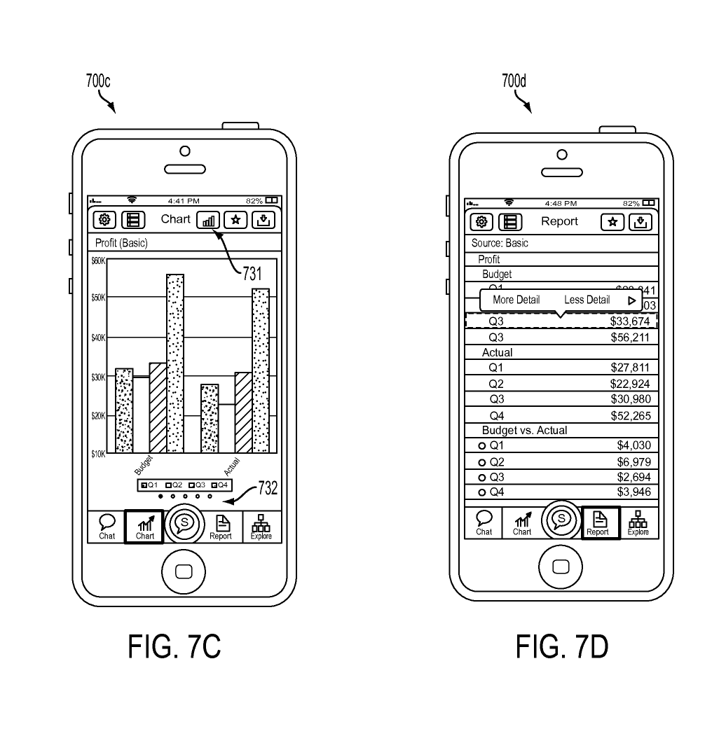

Further, in some embodiments, the query result may be displayed in three optional views—a chat screen, a chart screen, and a report screen. FIGS. 7A-7D illustrate these views.

FIGS. 7A and 7B illustrate exemplary screen views of the query result displayed on a chart screen. In some embodiments, the chat screen may be a default screen that users first see after logging in. A user may activate the voice recognition and input a query by speaking it. The chat screen may then show the user's spoken question in written format (the text version) and also show the queried answer. Alternatively, a user may also directly type in the question instead of inputting it by voice. A chat screen may be a preferred method of interacting with the application installed on the platform/server 200, although other interactive mechanism may be used.

FIG. 7A shows an exemplary chat screen 700. In this example, a user inputs a query on the profit for Boston (not shown), and the server returned a result, which is displayed in textual format as shown in 702. Then, the user follows up with another query by typing or speaking, and the user's follow-up query is extracted in textual format and displayed (“profit for all months”) as shown in 701. The server then returns the result, for example, by displaying a text “check out the charts or report I generated for you.” The user may continue follow-up queries. There may be provided an icon near a chat bubble, as shown in 704, to show that a query has been run successfully. This icon may be also used to repeat the same query, for example, as long as it is viewable on the chat screen.

In some embodiments, a third party user, who is different from the user making a query to the server, may join the chat conversation between the user and the server. For example, as shown in the figure, a third party user joins a thread of queries by the user (703), and depending on security settings, the third party user may see the user's previously queried answers, run the same queries, build follow up queries on the user's previous queries, or merely engage in simple text conversation with the user.

Further, a status message (705) may be provided to show when one or more changes occur in a thread of queries. The status message may also be shown when some changes occur and back tracking would be made difficult. Changes triggering the status message may include a third party user's participation, changes in data sources, etc.

FIG. 7B shows a number of exemplary options that users can engage with the queried result. For example, the figure shows three options (706)—“reply”, “query” or “share query”—and these options may pop up once the user clicks a query result. In particular, “share query” option allows the user to send the selected queried result to others via text, email, or any other electronic method, and those who received the queried result may run the same query, or run additional follow up queries building on the received query result, etc. Advantages of this feature include that the receiving side may be located remotely from the user, or even not communicable with the user, but still may be able to explore the received queried result, modify/expand/reduce the query in any way desirable. This feature may enhance the speed and efficiency of communication and reporting process.

FIG. 7C shows an exemplary chart screen 700c. A chart screen may show a bar chart of the query results, and may include one or more charts based on the dataset. Further, a chart screen may allow users to select different chart designs and switch among them based on the available data.

For example, the most recent query may contain multiple chart views, and then the switch chart button (731) may become enabled. To switch the chart, user may simply click the switch chart button and selected a desired chart type. Available chart types may include a bar graph, a 3-D bar graph, a pie chart, a vertical bar, a horizontal bar, a divided bar, etc.

Additionally or alternatively, the multiple chart views of the query result may be made viewable by users swiping left or right on the screen, as shown in dots 732. The dots may represent different chart pages.

FIG. 7D illustrates an exemplary report screen 700d. In some embodiments, the same information from the chart or chat screen may be displayed on a report screen in an interactive table. Owing to the interactive nature of this table, more or less information can be viewed on the table by making a certain touch on the screen (e.g., swiping from the bottom to the top of the screen, etc.). The table may also be changed to show different information by selecting a line in the report and selecting one of the following options: “less detail” (e.g., selecting less detail on January may bring it to Q1); “more detail” (e.g., selecting more detail on Q1 may bring it to January, February, and March); “remove” (e.g., the selected line is removed from the report); “keep only” (e.g., only the selected line is kept in the report); “promote/demote” (moving the selected line up or down the report); “best fit” (the view is rearranged in a pre-designated best fit format); and “share query” (the query report may be sent to other users, and recipients may be alerted and have option to run the report again or build follow up queries on the received report).

Further, the platform may provide users with the ability to rearrange the displayed data using, for example, different pivots. For example, different axes may be selected for different types of data (e.g., x-axis or y-axis) to re-display, or re-organize the same data within the same output format (e.g., a graph). Referring to the example shown in FIG. 4, the user may first see P&L market information and then the month and then the account details, or may rearrange the data in any other order. For example, the user may change the view (i.e., pivot) to show the month data first, then the market, then the account data.

Further, in some embodiments, the platform allows users to initiate a query in various ways—such as typing a textual query, speaking a voice query, and pulling a query that has been previously made or stored. For example, a user may store one or more queries as favorites and pull any one or more of them whenever s/he wants to run the queries. A user may also receive a query made by others (e.g., an SMS message of the query result shared with the user) and run the same query by just clicking or otherwise simply referring to this query.

Further, in some embodiments, when a user receives a query result from others (who shared a query result with the user), the user may not only see the query result and run the same query using his own device, but also can build a follow up query using his own device from the shared query. For example, the user may receive from others a query result outputted in a chart screen via a text message. Upon seeing this text message and the chart output, the user may decide to run the same query using his own device for any updates. Further, the same user may make a follow up query request (using his own device) to add or remove any one or more dimensions from the charted output data—e.g., requesting to add or remove any information from the shared chart. Upon receiving this request, the platform recognizes that this request is a follow up to the original query even though the follow query and the original query are not made from the same person, and the platform returns the modified chart to the user. These features may allow receivers of the query results to interact with the shared data more directly and intuitively (thereby, allowing them to get answers to any questions or concerns more efficiently) without having to go back the person who first shared the data.

The above features are not limited to a particular type of output screen, and instead, may be incorporated in all screen types including a chat screen, a chart screen, and a report screen. For example, in a chat screen, if a query initiator or a query recipient enters a follow up query request (e.g., add Chicago to the original query on the profit for Boston), the server returns a text result showing the profit for Chicago compared to the original query result of the profit for Boston. In a bar-graph screen (e.g., FIG. 7C), if the same follow up query is made with regard to the same original request, a bar showing the profit for Chicago is instantaneously added next to the bar showing the profit for Boston. In a report screen (e.g., FIG. 7D), upon the same follow up query, a report tab that is dedicated to the profit for Chicago is instantaneously added near the tab showing the profit for Boston. Similarly, a follow-up query may be made to remove or substitute any portion of the displayed output data.

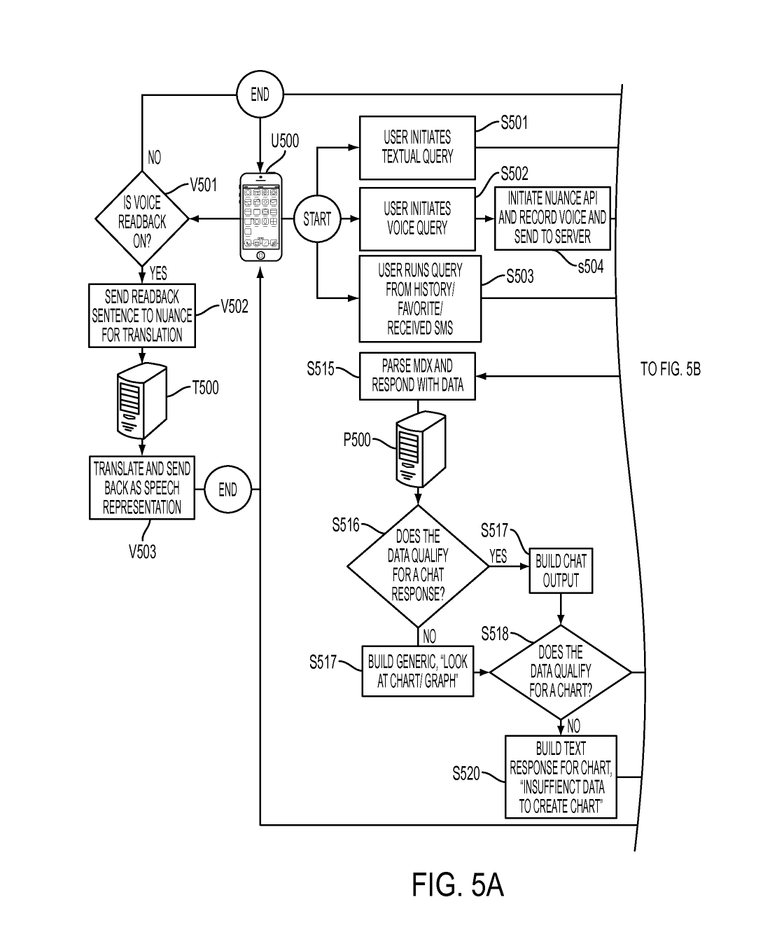

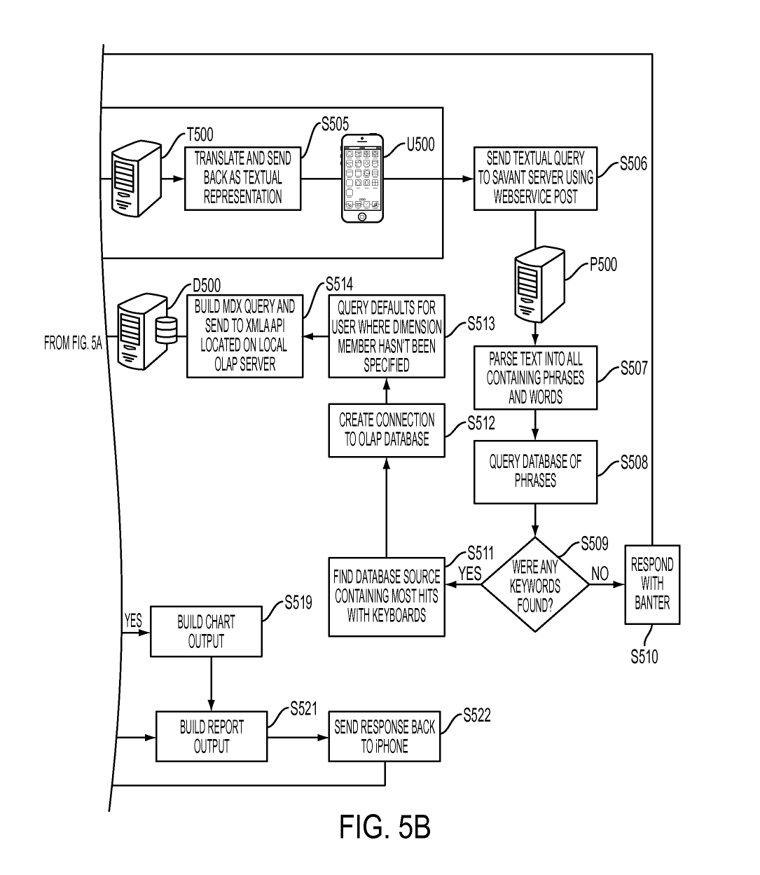

FIGS. 5a and 5b illustrate another example of a processing flow of a query platform or system. In this example, the platform includes a user device U500, a voice recognition server T500, a backend server P500, and/or one or more databases D500. User device U500 may take a query request in three ways—user may type in a textual query (S501), user may input (speak) a voice query (S502), or user may find a query that is pre-stored in the device as History, Favorites, or Messages received from other uses (S503).

If the user inputs a voice query, the application/plug-in for the voice recognition that is (or has been) initiated records the user's voice query and sends it to the voice processing server T500. The voice processing server T500 converts the voice file into a text file and sends this textual representation of the user's voice query back to the user device U500. The user device then sends this textual representation of the query to the query processing server P500, as shown in S506.

Although FIG. 5a shows an external voice recognizing server to process the audio for conversion to and from a text string, the externality of the voice recognition service is optional and may actually fit within the user device. The user device U500 may install a plug-in that allows it to recognize audio inputs and convert it to a text string. Then, the user device will not need to send the audio file/text file to external server T500 to get the corresponding text file/audio file.

The query processing server P500 parses the received text(s) into all containing words and phrases (S507), and queries the databases of alias tables associating one or more words and phrases to keywords (S508). If no matching keyword is found in the parsed request (S509), the server sends a message to the user device with a banter response (S510). The banter response may prompt the user to further specify the request, enter a new request, etc. A similar banter response may be used when the parsed request contains insufficient information (keywords) to select a correct database and/or to formulate a query.

If there is a sufficient number of matching keywords found in the parsed request (S509), the server P500 finds a database source containing the most hits with the keywords (S511) that are found, creates a connection to the selected database source (S512), and formulates a query. If there is any dimension member that has not been specified by user in the query request, the server obtains the user's pre-stored default values for the missing dimension information (S513). Once the server builds a query readable by the database, (S514) a MDX query may be generated and sent to XMLA API located on local OLAP server, the server sends the query to the selected database source. The database D500 receiving the query parses the query and responds with queried data (S515).

The query processing server P500 receives the queried data from the database source, and determines whether the received data qualifies for a chat response. The chat response includes a textual representation of the data such that the text representing the data can be displayed and/or read back on the user device (S516). If it qualifies, the server P500 builds a chat output (e.g., a textual representation of the retrieved data) and then further determines whether the same data can be output in different formats such as a chart format or a report format (S518 and S521). If the data qualifies for any other formats, the server builds the output in such formats (S517 and S519), and if not, the server generates a text response indicating that the data is insufficient to create [a certain output format] (S520). Even though the example shown in FIGS. 5a and 5b builds the chat output first and then builds the chart and the report outputs, the order of building different outputs can be modified in any way. Typically, most financial data will qualify for a report output format than for a chat or chart format. After the retrieved data is outputted in all available formats, the server P500 sends all of the outputs to the user device U500.

In this example, the voice recognition processing flow may be used when the user inputs a voice query, and/or the retrieved data (received from the server by the user device) is set for playback on the user device (V501). In the former case, the voice recognition application or a similar plug-in on the user device may be activated to record a user's voice query, store it in a sound file, send this sound file to voice processing server T500, and receives a textual representation of the voice query from the server T500. In the latter case, the user device U500 may receive a textual representation of the retrieved (queried) data from the query processing server P500, send this text to voice processing server as shown in V502, and receive from this server a speech representation (sound file) of the queried data for playback on the user device (V503). Further, as mentioned above, the externality of the voice recognition feature is option and may be handled entirely by the processors in the user device using appropriate plug-ins.

The description above sets forth only a few of the many exemplary embodiments that can be realized by implementing the ideas envisioned by the present inventors, it being impractical to set forth in writing all of the many, possible or potential embodiments. For example, all types of “Account” type information, other than “revenue” may be retrieved, such as cost of goods sold, profit margin, operating expenses, operating income to name just a few, by inputting an appropriate query. All types of keywords may be used to create or modify a query and/or be stored in memory, such as “add”, “more detail”, “less detail”, “repeat”, “redo,” to name just a few. For example, if a user inputs a query “Total sales for all months”, an exemplary device may generate and display a visual showing the sales revenue for every month on a display. If the user then inputs a query “add budget”, the exemplary device may modify the existing visual by adding the budget sales data as a new series in the visual.

It will be appreciated that the above description for clarity has described embodiments of the disclosure with reference to different functional units and processors. However, it will be apparent that any suitable distribution of functionality between different functional units or processors may be used without detracting from the disclosure. For example, functionality illustrated to be performed by separate systems may be performed by the same system, and functionality illustrated to be performed by the same system may be performed by separate systems. Hence, references to specific functional units may be seen as references to suitable means for providing the described functionality rather than indicative of a strict logical or physical structure or organization.

The disclosure may be implemented in any suitable form, including hardware, software, firmware, or any combination of these. The disclosure may optionally be implemented partly as computer software running on one or more data processors and/or digital signal processors. The elements and components of an embodiment of the disclosure may be physically, functionally, and logically implemented in any suitable way. Indeed, the functionality may be implemented in a single unit, in a plurality of units, or as part of other functional units. As such, the disclosure may be implemented in a single unit or may be physically and functionally distributed between different units and processors.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A method for responding to natural language financial performance queries received from a user device, comprising:
receiving a first request for a query from the user device, the request being a text string of a natural language;
parsing the first request into one or more parsed natural language words, using a processor;
searching a table of natural language words and keywords to determine whether the parsed natural language words match any of the natural language words in the table;
generating instructions for querying a database based on one or more keywords corresponding to the matched natural language words in the table;
receiving first information responding to the first request from the database; and
transmitting the first information to the user device.

2. The method of claim 1, further comprising;
receiving a second request for a query from the user device;
determining that the second request is associated with the first request; and
transmitting second information responding to the second request and at least a part of the associated first information together to the user device.

3. The method of claim 1, further comprising;
receiving a second request to run the first request again from the user device;
determining that the second request is associated with the first request; and
transmitting updated first information to the user device.

4. The method of claim 1, further comprising;
receiving a second request for a query from a second device different from the user device;
determining that the second request is associated with the first request; and
transmitting second information responding to the second request and at least a part of the associated first information together to the second device.

5. The method of claim 1, further comprising;
receiving a second request to edit the previously transmitted first information;
determining that the second request is associated with the first request; and
transmitting edited first information.

6. The method of claim 2, wherein the second request is determined to be associated with the first request based on one or more parsed natural language words in the second request.

7. The method of claim 1, wherein the keywords in the table relate to financial information stored in the database.

8. The method of claim 1, wherein the transmitted information is represented in a chart or a table format

9. The method of claim 1, wherein the transmitted information is converted to an audio for playback on the user device.

10. The method of claim 1, further comprising selecting a database from a plurality of databases based on at least one of the parsed natural language words in the first request, and one or more previous requests received from the user device.

11. A method for communicating with a server relating to natural language financial performance queries, comprising:
receiving a first spoken natural language request for a query from a user;
transmitting a first textual request corresponding to the first spoken request to the server;
receiving first financial information responding to the first request from the server; and
displaying the first financial information.

12. The method of claim 11, further comprising:
receiving a second spoken natural language request for a query from the user, the second request associated with the first request; and
transmitting a second textual request corresponding to the second spoken request to the server;
displaying second financial information responding to the second request together with at least a part of the first financial information.

13. The method of claim 11, further comprising converting the first spoken natural language request to the first textual request using an application dedicated for voice recognition.

14. The method of claim 11, further comprising:
transmitting the first spoken natural language request to a voice recognition server located remotely from a user device; and
receiving the first textual request from the voice recognition server.

15. The method of claim 11, further comprising:
converting the first financial information into an audio; and
playing the audio.

16. The method of claim 11, wherein the first financial information is displayed in a chart or a table format.

17. The method of claim 12, wherein the second financial information and the first financial information are displayed together in a chart or a table format.

18. The method of claim 11, further comprising;
receiving a second spoken natural language request to edit the displayed financial information; and
re-displaying the financial information edited in accordance with the second request.

19. The method of claim 11, further comprising:
receiving a second spoken natural language request to share the displayed information with a second device; and
transmitting the displayed information to the second device.

20. A system for responding to natural language financial performance queries received from a user device, comprising a central server and a plurality of user devices each configured to communicate with the central server, wherein
the central server comprises a processor configured to perform:
receiving a first request for a query from a user device, the request being a text string of a natural language;
parsing the first request into one or more parsed natural language words, using a processor;
searching a table of natural language words and keywords to determine whether the parsed natural language words match any of the natural language words in the table;
generating instructions for querying a database based on one or more keywords corresponding to the matched natural language words in the table;
receiving first information responding to the first request from the database; and
transmitting the first information to the user device, and
at least one of the plurality of user devices comprises a processor configured to perform:
receiving a first spoken natural language request for a query from a user;
transmitting a first textual request corresponding to the first spoken request to the server;
receiving first financial information responding to the first request from the server; and
displaying the first financial information.

21. The system of claim 20, wherein the central server is further configured to perform:
receiving a second request for a query from the user device;
determining that the second request is associated with the first request; and
transmitting second information responding to the second request and at least a part of the associated first information together to the user device.

22. The system of claim 20, wherein the central server is further configured to perform:
receiving a second request for a query from a second device different from the user device;
determining that the second request is associated with the first request; and
transmitting second information responding to the second request and at least a part of the associated first information together to the second device.

23. The method of claim 20, wherein the first financial information is converted to an audio, and the audio is played back while the first financial information is being displayed on the user device.

24. The method of claim 21, wherein the second financial information and the first financial information are displayed together in a chart or a table format.

25. The method of claim 20, wherein the at least one of the plurality of user devices is further configured to perform:
transmitting the first spoken natural language request to a voice recognition server located remotely from a user device; and
receiving the first textual request from the voice recognition server.
